(19) United States
(12) Patent Application Publication
(10) Pub. No.: US 2016/0021167 A1
(43) Pub. Date: Jan. 21, 2016

(54) METHOD FOR EXTENDING VEHICLE INTERFACE

(71) Applicant: Hyundai Motor Company, Seoul (KR)

(72) Inventors: Un Kyu Park, Seoul (KR); Byung Sik Choi, Osan (KR)

(21) Appl. No.: 14/795,015

(22) Filed: Jul. 9, 2015

(30) Foreign Application Priority Data
Jul. 17, 2014 (KR) 10-2014-0090552

(51) Int. Cl. H04L 29/08; H04W 64/00; H04W 4/00

(52) U.S. Cl. CPC H04L 67/025; H04W 4/008; H04W 64/003; H04L 67/12; H04W 88/02

(57) ABSTRACT

A method for determining a position of a wireless terminal belonging to a passenger positioned in a vehicle; providing interworking devices among devices provided in the vehicle interworking with the wireless terminal based on the position of the wireless terminal; bi-directionally interworking a device selected by the passenger among the provided interworking devices and the wireless terminal with each other through short range communication; and controlling the selected device through a display of the wireless terminal.

### CROSS-REFERENCE TO RELATED APPLICATION

This application claims the benefit of and priority to Korean Patent Application No. 10-2014-0090552, filed on Jul. 17, 2014 in the Korean Intellectual Property Office, the disclosure of which is incorporated herein in its entirety by reference.

### TECHNICAL FIELD

The present disclosure relates generally to a method for extending a vehicle interface, and more particularly, to a method for extending a vehicle interface in which an interface controlling devices in a vehicle is provided through a portable device of a passenger.

### BACKGROUND

In accordance with the recent development of communication and multimedia technology, navigation devices, head-up displays, and the like, have been installed in vehicles. Moreover, a user interface (UI) and user experience (UX) that combines a terminal in a vehicle with a cellular phone have been developed in various forms. For instance, a conventional user experience device for a vehicle has used a 7-inch or 8-inch piezoelectric touch screen. In addition, most smart phones have adopted a drag-and-drop-type user interface using a capacitive touch screen based on the given smart phone platform. Furthermore, techniques for interworking a screen of the smart phone with a screen of the vehicle have been developed.

Generally, an audio-visual-navigation (AVN) terminal has been used in order to intuitively provide vehicle-related information and entertainment to a driver within the vehicle. However, the AVN terminal is typically positioned at the center of the front seat of the vehicle and generally includes a limited number of screens.

In addition, should a user attempt to access an interface that controls the AVN in order to search for desired content in a driving situation, the content which may be controlled by a corresponding interface is limited. Similarly, other devices in a vehicle, such as an air conditioner, window, or the like, are generally controlled by a physical button, lever, or the like.

### SUMMARY

The present disclosure has been made to solve the above-mentioned problems occurring in the related art while advantages achieved by the related art are maintained intact.

An aspect of the present disclosure provides a method for extending a vehicle interface in which a wireless terminal of a passenger including a display interworks with various devices of a vehicle to provide an interface provided in the vehicle about the interworking devices or provide an interface added to a corresponding interface through the display of the wireless terminal.

According to embodiments of the present disclosure, a method for extending a vehicle interface includes: determining a position of a wireless terminal belonging to a passenger positioned in a vehicle; providing interworking devices among devices provided in the vehicle interworking with the wireless terminal based on the position of the wireless terminal; bi-directionally interworking a device selected by the passenger among the provided interworking devices and the wireless terminal with each other through short range communication; and controlling the selected device through a display of the wireless terminal.

The bi-directional interworking of the selected and the wireless terminal with each other may include: determining whether the selected device includes a display; providing an extension interface controlling the selected device and information indicating a state of the selected device to the passenger through a multi-display including the display of the selected device and the display of the wireless terminal, upon determining that the selected device includes a display; and providing an extension interface controlling the selected device and the information indicating the state of the selected device to the passenger through a virtual screen of the display of the wireless terminal, upon determining that the selected device does not include a display.

The method may further determining the position of the wireless terminal based on information about the position of the wireless terminal obtained through at least one of: a camera in the vehicle, near field communication (NFC) tagging, Bluetooth, WiFi, and a quick response (QR) code and information about the position of the wireless terminal obtained through a position sensor provided in the wireless terminal.

A function selected by the passenger through the extension interface may be displayed only on the display of the wireless terminal, and the other functions of the extension interface and the information indicating the state of the selected device may be displayed only on the display of the selected device.

The bi-directional interworking of the selected and the wireless terminal with each other may further include recognizing a gesture of the passenger, where the selection of the passenger may be recognized through a gesture.

The extension interface may extend a lower menu of an interface included in the vehicle to an upper menu or include an extended function of the selected device that is not included in the interface, in order to control the selected device.

When the selected device is an audio-visual-navigation (AVN) device, the wireless terminal may be positioned at an upper side, a lower side, or a right side of a display of the AVN device to interwork with the AVN device.

When the selected device is a display in front of a passenger seat, the wireless terminal may be positioned at an upper side, a lower side, a left side, or a right side of the display to interwork with the display.

When the selected device is an AVN device, in a case in which the wireless terminal is positioned between the AVN device and an air conditioning device, both of the AVN device and the air conditioning device may be used as the interworking devices.

A displayed content may be controlled by a selection of the passenger based on the position of the wireless terminal in the vicinity of the AVN device.

Furthermore, according to embodiments of the present disclosure, a non-transitory computer readable medium containing program instructions for extending a vehicle interface includes: program instructions that determine a position of a wireless terminal belonging to a passenger positioned in a vehicle; program instructions that provide interworking devices among devices provided in the vehicle interworking with the wireless terminal based on the position of the wireless terminal; program instructions that bi-directionally interwork a device selected by the passenger among the provided interworking devices and the wireless terminal with each other through short range communication; and program instructions that control the selected device through a display of the wireless terminal.

### BRIEF DESCRIPTION OF THE DRAWINGS

The above and other objects, features and advantages of the present disclosure will be more apparent from the following detailed description taken in conjunction with the accompanying drawings.

FIG. 1 is a view illustrating a position of a wireless terminal in a vehicle in a method for extending a vehicle interface according to embodiments of the present disclosure.

FIG. 2 is a view illustrating a method for extending a vehicle interface of a system for extending a vehicle interface according to embodiments of the present disclosure.

FIG. 3 is a view illustrating that the wireless terminal is positioned in the vicinity of an audio visual navigation (AVN) in the vehicle to interwork with the AVN in the method for extending a vehicle interface according to embodiments of the present disclosure.

FIG. 4 is a view illustrating that the wireless terminal is positioned at a vehicle door to interwork with the vehicle door in the method for extending a vehicle interface according to embodiments of the present disclosure.

### DETAILED DESCRIPTION OF THE EMBODIMENTS

Advantages and features of the present disclosure and methods accomplishing them will become apparent from embodiments described below in detail with reference to the accompanying drawings. However, the present disclosure is not limited to embodiments described herein, but may be implemented in other forms. These embodiments are provided in order to describe the present disclosure in detail so that those skilled in the art to which the present disclosure pertains may easily practice the spirit of the present disclosure.

In the accompanying drawings, embodiments of the present disclosure are not limited to illustrated specific forms, but are exaggerated for the purpose of clarity. Although specific terms have been used in the present specification, they are used in order to describe the present disclose and are not used in order to limit the meaning or the scope of the present disclosure, which is disclosed in the appended claims.

In the present specification, a term ‘and/or’ is used as the meaning including at least one of components arranged before and after the term. In addition, terms ‘connected/coupled’ are used as the meaning including that any component is directly connected to another component or is indirectly connected to another component through the other component. Unless explicitly described to the contrary, a singular form includes a plural form in the present specification. In addition, components, steps, operations, and/or elements mentioned by terms ‘include’ or ‘including’ used in the present specification mean the existence or addition of one or more other components, steps, operations, and/or elements.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one control unit. The term “control unit” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the control unit in conjunction with one or more other components, as would be appreciated by a person of ordinary skill in the art.

Furthermore, the control unit of the present disclosure may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Hereinafter, embodiments of the present disclosure will be described in detail with reference to the accompanying drawings.

The present disclosure relates to a technology of interworking a display of a wireless terminal generally possessed by a passenger getting in a vehicle with a device included in the vehicle to control the corresponding device, and provides an interface interworking with a device present in the vicinity thereof based on a position of the wireless terminal in the vehicle to control the corresponding device in an extended form.

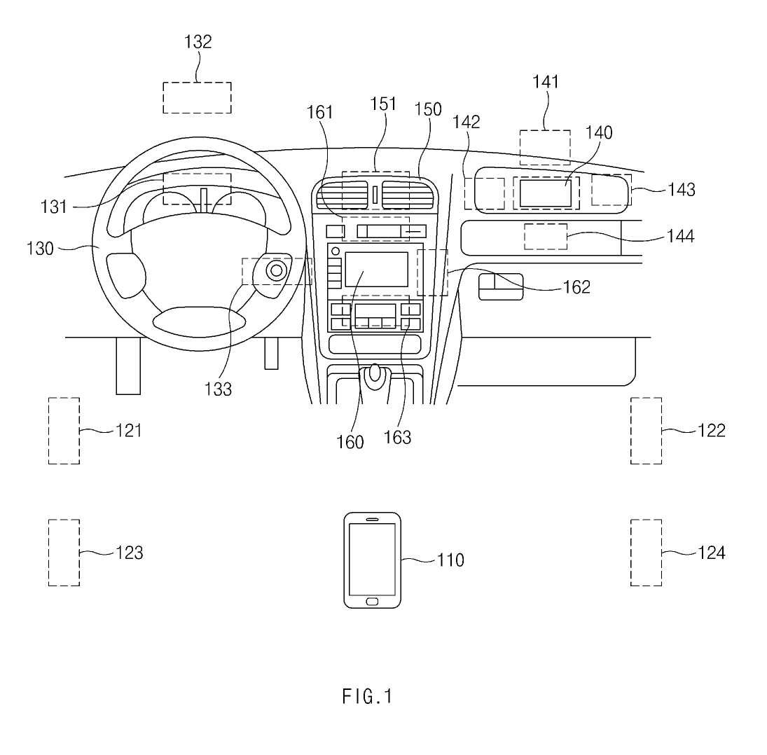

FIG. 1 is a view illustrating a position of a wireless terminal in a vehicle in a method for extending a vehicle interface according to embodiments of the present disclosure. Although a front seat of the vehicle will be mainly described for convenience of explanation in FIG. 1, it should be understood that the disclosed content can be similarly applied to a rear seat of the vehicle.

The front seat of the vehicle is provided with various devices 130, 140, 150, and 160. In detail, a handle 130, an air conditioning device 150 such as an air conditioner, an audio visual navigation (AVN) 160, and the like, are provided, and, a display unit 140 may be provided in front of a passenger seat if necessary. In addition, doors 121 to 124 of the vehicle, and the like, may be provided. However, devices of the vehicle to be described below are not limited to only the devices as described above.

A wireless terminal 110 belonging to a vehicle passenger may be put or positioned at several positions 131, 132, and 133 in the vehicle, based on a handle 130, or be positioned at a position 151 in the vicinity of the air conditioning device 150. In addition, the wireless terminal 110 may be put or positioned at an upper side 161, a lower side 163, or a right side 162 based on the AVN 160, and be put or positioned at an upper side 141, a lower side 144, a left side 142, or a right side 143 of the display unit 140 when the display unit 140 is present in front of the passenger seat.

The present disclosure may interwork all devices in the vicinity of a position at which the wireless terminal may be positioned as well as infortainment devices of the vehicle to control the corresponding devices by an extended interface.

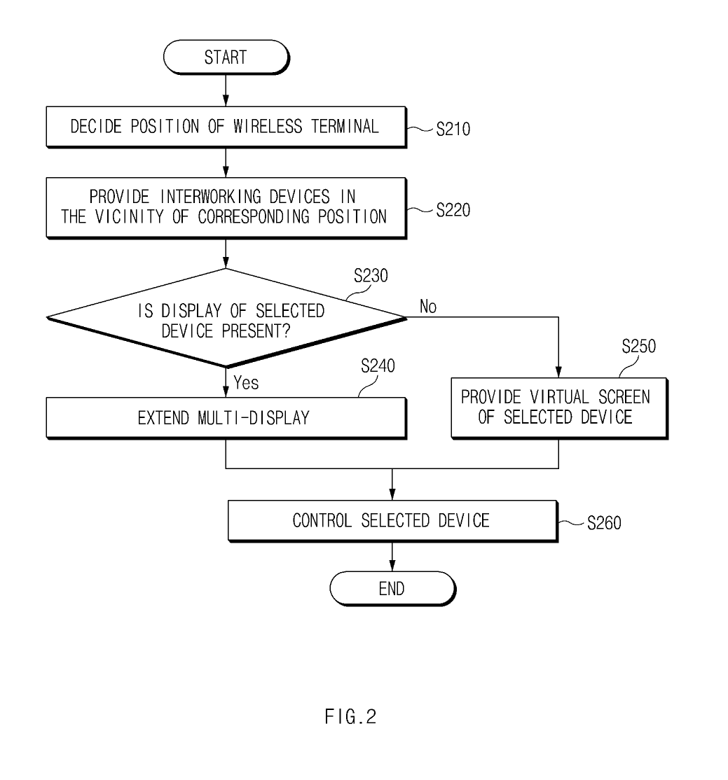

FIG. 2 is a view illustrating a method for extending a vehicle interface of a system for extending a vehicle interface according to embodiments of the present disclosure.

The system for extending a vehicle interface includes a wireless terminal position deciding unit, a wireless terminal interworking device providing unit, and a display extension deciding unit.

First, the wireless terminal position deciding unit determines a position of the wireless terminal possessed by a passenger getting in the vehicle and put or positioned in the vehicle (S210). The position of the wireless terminal in the vehicle may be determined by the wireless terminal position deciding unit by analyzing an image of an indoor camera provided in the vehicle or tagging a near field communication (NFC) tag provided in various devices of the vehicle. In addition, the position of the wireless terminal in the vehicle may be determined by analyzing a signal of Bluetooth or WiFi connected between the vehicle and the wireless terminal or be decided by using quick response (QR) codes provided in various devices of the vehicle. In addition, the position of the wireless terminal in the vehicle may be determined based on information on the position of the wireless terminal, obtained through a position sensor included in the wireless terminal itself, for example, a gyroscope, an acceleration sensor, a compass pressure sensor, or the like.

Then, the wireless terminal interworking device providing unit provides devices that are present in the vicinity of the position of the wireless terminal decided in S210 and may interwork with the wireless terminal among various devices provided in the vehicle to the passenger (S220). For example, in the case in which the wireless terminal is positioned in the vicinity of the handle, the handle may be provided as an interworking device to the passenger, and in the case in which the wireless terminal is positioned between the AVN device and the air conditioning device, both of the AVN device and the air conditioning device may be provided as interworking devices to the passenger.

Then, the device selected by the passenger among the interworking devices provided in S220 interworks with the wireless terminal (S230 to S250). Here, the selected device may bi-directionally interwork with the wireless terminal through short range communication such as WiFi, NFC, Bluetooth, universal serial bus (USB) connection, or the like, but is not limited thereto.

Hereinafter, the interworking between the selected device and the wireless terminal will be described in more detail. An interworking form is divided based on whether or not the corresponding selected device includes a display device.

First, the display extension deciding unit determines whether the selected device includes a display (S230), and an interface that may control the selected device additionally uses a display of the interworking wireless terminal in the case in which it is determined that the device selected by the passenger includes the display. That is, an interface controlling the selected device and information indicating a state of the selected device are visually provided to the passenger using the display of the selected device and the display of the wireless terminal in a multi-display form, and since the display is additionally increased, the interface displayed in this case is not simply the selected interface itself, but is an extension interface (S240).

In addition, in a case in which it is decided that the selected device does not include the display, an interface that may control the selected device and information indicating a state of the selected device are provided as a virtual screen on the display of the wireless terminal to the passenger (S250). The interface in this case is also an extension interface controlling the selected device.

The extension interfaces of S240 and S250 may be interfaces representing more menus at a glance by extending a lower menu of a basic interface already provided through the display of the selected device in order to control the selected device to an upper menu. Alternatively, the extension interface may be an interface including an extended function, which is a function that is not included in the basic interface, such that it is not a control target, but is additionally provided to the passenger.

As a result, in controlling the selected device, the extension device not only provides the basic interface basically provided through a limited space to the passenger, but is also additionally used as an interface of the selected device through the wireless terminal of the passenger. Therefore, the extension interface may extend the lower menu to the upper menu or control an additional function that is not provided in the basic interface.

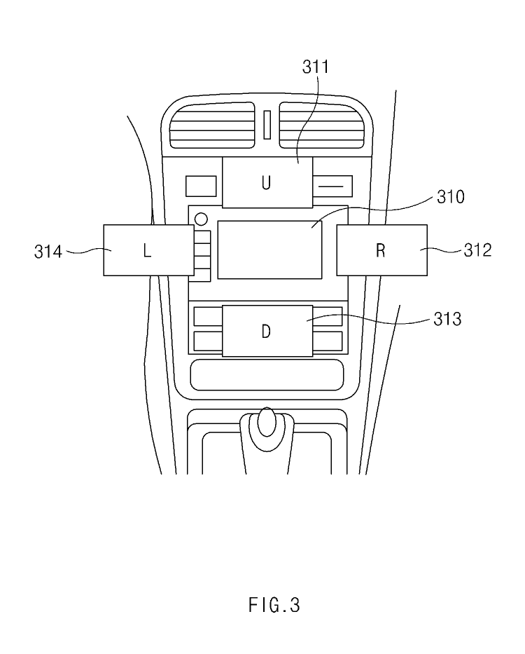

FIG. 3 is a view illustrating that the wireless terminal is positioned in the vicinity of an audio visual navigation (AVN) device in the vehicle to interwork with the AVN device in the method for extending a vehicle interface according to embodiments of the present disclosure.

The wireless terminal may be put or positioned at an upper side 311, a lower side 313, a right side 312, or a left side 314 of an AVN device 310 of the vehicle. In this case, the wireless terminal may interwork with the AVN device 310, and provide an interface that may control the AVN through a display provided in the wireless terminal to the passenger. Particularly, a displayed content may be controlled by selection of the passenger depending on a position of the wireless terminal in the vicinity of the AVN device 310.

In more detail, in the case in which the passenger frequently uses some of functions in the extension interface described above, he/she may select the corresponding functions to allow the corresponding functions to be displayed on only the display of the wireless terminal, and may perform a control so that the other functions in the extension interface and information indicating a state of the selected device are displayed on a display of the AVN device 310. This may be freely determined depending on a position of the passenger and a frequently used function.

Here, the selection of the passenger may be made by touching a touch screen in the case in which the corresponding interface is the touch screen. However, in the case of recognizing a gesture such as hand movement of the passenger, a function that is to be displayed on only the wireless terminal may be selected through a gesture for moving the frequently used function from the AVN device 310 to a position of the wireless terminal.

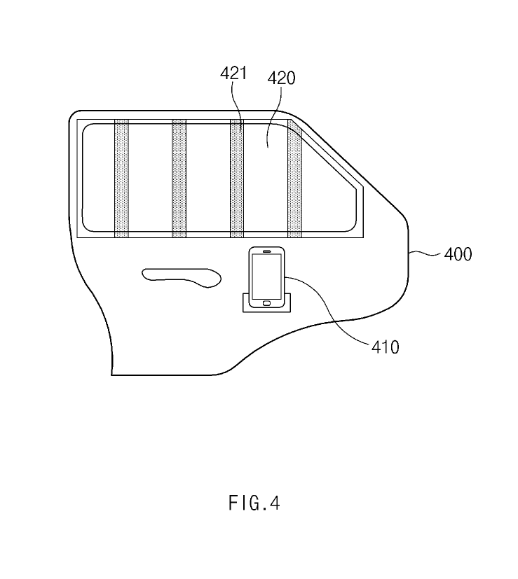

FIG. 4 is a view illustrating that the wireless terminal is positioned at a vehicle door to interwork with the vehicle door in the method for extending a vehicle interface according to embodiments of the present disclosure.

Generally, in the case of a vehicle window, only a function of opening and lowering a corresponding window is provided as a simple hard key to the passenger. The reason is that there is a limitation in a space of the vehicle door itself or separate other functions are not mounted in the vehicle window.

However, in accordance with the development of a technology, a curtain function 421 may be mounted on the window by adjusting transmissivity of light. In this case, interfaces for precisely controlling a corresponding function need to be provided. However, it is not easy to mount the interfaces for precisely controlling the corresponding function on all of the vehicle doors.

Therefore, as illustrated in FIG. 4, in the case in which the wireless terminal 410 is positioned at the vehicle door 400, since the vehicle door 400 is a device that does not include the display, as described above, an extension interface for controlling the curtain function 421 of the vehicle window 420 provided in the vehicle door 400 may be provided to the passenger through the wireless terminal 410. That is, the passenger may visually precisely recognize the extension interface and information on the vehicle window 420 displayed on his/her wireless terminal 410 and perform a control depending on the recognition.

In the method for extending a vehicle interface according to embodiments of the present disclosure, even though interfaces (e.g., a hard key and a soft key) for controlling various devices provided in the vehicle are not provided in the vehicle itself, the corresponding devices may be controlled, the menu mounted as the lower menu due to a limitation in a display space of an already provided interface may be extended to the upper menu, and the surrounding devices may be selectively controlled depending on positions of the wireless terminal in the vehicle. Furthermore, the wireless terminal of the passenger interworks with various devices of the vehicle, thereby making it possible to provide the interface provided in the vehicle for interworking of the devices or provide the interface added to the corresponding interface through the display of the wireless terminal.

Although the embodiments of the present disclosure have been described hereinabove, it is to be understood that several modifications of the present disclosure may be made without departing from the scope of the present disclosure. Therefore, the scope of the present disclosure is not to be limited to the above-mentioned embodiments, but is to be defined by the following claims and equivalents thereto. When considering the above-mentioned content, in the case in which modifications and alternations of the present disclosure fall within the scope of the following claims and equivalents thereto, it is to be considered that the present disclosure includes these modifications and alternations.

What is claimed is:

1. A method for extending a vehicle interface, comprising:
determining a position of a wireless terminal belonging to a passenger positioned in a vehicle;
providing interworking devices among devices provided in the vehicle interworking with the wireless terminal based on the position of the wireless terminal;
bi-directionally interworking a device selected by the passenger among the provided interworking devices and the wireless terminal with each other through short range communication; and
controlling the selected device through a display of the wireless terminal.

2. The method for extending a vehicle interface according to claim 1, wherein the bi-directional interworking of the selected and the wireless terminal with each other comprises:
determining whether the selected device includes a display;
providing an extension interface controlling the selected device and information indicating a state of the selected device to the passenger through a multi-display including the display of the selected device and the display of the wireless terminal, upon determining that the selected device includes a display; and
providing an extension interface controlling the selected device and the information indicating the state of the selected device to the passenger through a virtual screen of the display of the wireless terminal, upon determining that the selected device does not include a display.

3. The method for extending a vehicle interface according to claim 1, further comprising determining the position of the wireless terminal based on information about the position of the wireless terminal obtained through at least one of: a camera in the vehicle, near field communication (NFC) tagging, Bluetooth, WiFi, and a quick response (QR) code and information about the position of the wireless terminal obtained through a position sensor provided in the wireless terminal.

4. The method for extending a vehicle interface according to claim 2, wherein a function selected by the passenger through the extension interface is displayed only on the display of the wireless terminal, and
the other functions of the extension interface and the information indicating the state of the selected device are displayed only on the display of the selected device.

5. The method for extending a vehicle interface according to claim 4, wherein the bi-directional interworking of the selected device and the wireless terminal with each other further comprises:
recognizing a gesture of the passenger, wherein
the selection of the passenger is recognized through a gesture.

6. The method for extending a vehicle interface according to claim 2, wherein the extension interface extends a lower menu of an interface included in the vehicle to an upper menu or includes an extended function of the selected device that is not included in the interface, in order to control the selected device.

7. The method for extending a vehicle interface according to claim 1, wherein when the selected device is an audio-visual-navigation (AVN) device, the wireless terminal is positioned at an upper side, a lower side, or a right side of a display of the AVN device to interwork with the AVN device.

8. The method for extending a vehicle interface according to claim 1, wherein when the selected device is a display in front of a passenger seat, the wireless terminal is positioned at an upper side, a lower side, a left side, or a right side of the display to interwork with the display.

9. The method for extending a vehicle interface according to claim 1, wherein when the selected device is an AVN device, in a case in which the wireless terminal is positioned between the AVN device and an air conditioning device, both of the AVN device and the air conditioning device are used as the interworking devices.

10. The method for extending a vehicle interface according to claim 7, wherein a displayed content is controlled by a selection of the passenger based on the position of the wireless terminal in the vicinity of the AVN device.

11. A non-transitory computer readable medium containing program instructions for extending a vehicle interface, the computer readable medium comprising:
program instructions that determine a position of a wireless terminal belonging to a passenger positioned in a vehicle;
program instructions that provide interworking devices among devices provided in the vehicle interworking with the wireless terminal based on the position of the wireless terminal;
program instructions that bi-directionally interwork a device selected by the passenger among the provided interworking devices and the wireless terminal with each other through short range communication; and
program instructions that control the selected device through a display of the wireless terminal.
